(19) United States
(12) Patent Application Publication
(10) Pub. No.: US 2026/0311697 A1
(43) Pub. Date: Oct. 8, 2026

(54) METHOD AND APPARATUS FOR PROCESSING VOICE COMMAND

(71) Applicants: Hyundai Motor Company, Seoul (KR); Kia Corporation, Seoul (KR)

(72) Inventor: Chang Woo CHUN, Hwaseong-si (KR)

(73) Assignees: Hyundai Motor Company, Seoul (KR); Kia Corporation, Seoul (KR)

(21) Appl. No.: 19/369,640

(22) Filed: Oct. 27, 2025

(30) Foreign Application Priority Data
Apr. 3, 2025 (KR) 10-2025-0043506

(51) Int. Cl. G10L 15/22; G10L 15/26

(52) U.S. Cl. CPC G10L 15/22; G10L 15/26; G10L 2015/223

(57) ABSTRACT

A computer-implemented method performed by one or more computing devices for executing voice commands based on display information, the method including converting a user's utterance to text to obtain an input text string, prioritizing a plurality of on-screen texts displayed on a display screen, wherein the priority of the plurality of on-screen texts indicates the degree of relevance of the on-screen texts to the user's utterance intent, and executing a voice command corresponding to the highest priority text among the plurality of on-screen texts.

### CROSS-REFERENCE TO RELATED APPLICATIONS

This application claims priority to Korean Patent Application No. 10-2025-0043506, filed on Apr. 3, 2025, the entire contents of which are incorporated herein by reference.

### TECHNICAL FIELD

The present disclosure in some embodiments relates to a method and apparatus for processing voice commands. More particularly, the disclosure relates to a method and apparatus for processing voice commands to prevent or minimize conflicts between a plurality of global commands and a plurality of local commands.

### BACKGROUND

The statements in this section merely provide background information related to the present disclosure and do not necessarily constitute prior art.

Recently, the application of voice recognition services has been expanding into various fields such as automobiles. Voice recognition service allows users to control devices or software using their voices. The voice recognition service is provided in various devices, such as automobiles, smartphones, and home appliances, and helps users control devices without using their hands.

A vehicle equipped with a voice recognition service responds to the user's utterance by generating voice commands, which are used to control the vehicle. The user can lock/unlock the doors of the vehicle or adjust the temperature inside the vehicle by pre-activating the air conditioner.

For the utterance recognition service, the vehicle has an utterance recognition system that pre-stores a command table containing voice commands that are recognized by a software application and responds to the user's voice command by selecting and executing the control command that is most similar to the user's voice command from the command table.

The utterance recognition commands may be divided into “global commands” and “local commands.” Global commands are available to the user at any time while the utterance recognition feature is enabled, while local commands are available to the user only when a specific application screen is being displayed, i.e., the specific application is running while the utterance recognition feature is enabled. The user can execute the desired function by speaking the text displayed on the running application screen.

When a particular software application is running, a global command and a local command for the application may be executed. For example, if the global command and the local command both correspond to the user's utterance, a conflict may occur between the global command and local command, and the utterance recognition system may fail to issue control commands that meet the user's utterance intent. Conflicts may also occur between multiple global commands or between multiple local commands.

Therefore, in order for the user to conveniently use the utterance recognition system, there is a need for a method to prevent or minimize conflicts between multiple global commands and multiple local commands.

### SUMMARY

The present disclosure seeks to provide a method and apparatus for processing voice commands, which can prevent or minimize conflicts between a plurality of global commands and a plurality of local commands.

The objects of the present disclosure are not limited to those particularly described hereinabove, and the above and other objects that the present disclosure can achieve will be clearly understood by those skilled in the art from the following detailed description.

According to at least one embodiment, the present disclosure provides a computer-implemented method performed by a computing device to execute voice commands, the method including obtaining, by the computing device, an input text string by converting a user's utterance into text, determining, by the computing device, whether the input text string is classified into a highest priority command, determining, by the computing device, based on the input text string not being classified into the highest priority command, a priority of a plurality of texts displayed on a display screen, and executing, by the computing device, a voice command that corresponds to a highest priority text among the plurality of on-screen texts. Here, the highest priority command is a global voice command that is not displayed on the display screen, and the priority is determined based on a degree of relevance of text among the plurality of texts displayed on the display screen to an intent of the user's utterance.

According to another embodiment, the present disclosure provides an apparatus for executing voice commands based on display information, including a memory configured to store commands, and at least one processor. The at least one processor is configured to execute the commands to: determine an input text string by converting user's utterance into text, determine whether the input text string is classified into a highest priority command, determine, based on the input text string not being classified into the highest priority command, a priority of a plurality of texts displayed on a display screen, and execute a voice command that corresponds to a highest priority text among the plurality of on-screen texts. Here, the highest priority command is a global voice command that is not displayed on the display screen, and the priority represents a degree of relevance of text among plurality of texts displayed on the display screen to an intent of the user's utterance.

According to an embodiment of the present disclosure, it is possible to prevent or minimize conflicts between a plurality of global commands and a plurality of local commands.

According to an embodiment of the present disclosure, by preventing or minimizing conflicts between a plurality of global commands and a plurality of local commands, it is possible to execute a control command that aligns with the user's utterance intent, thereby improving the convenience of the voice recognition system.

The effects of the present disclosure are not limited to those mentioned above, and other effects not explicitly stated can also be clearly understood by those skilled in the art from the following description.

### BRIEF DESCRIPTION OF THE DRAWINGS

FIG. 1 is a schematic block diagram of an overall system according to at least one embodiment of the present disclosure.

FIG. 2 is a block diagram of an utterance recognition system according to at least one embodiment of the present disclosure.

FIG. 3 illustrates a display screen composed of multiple layers.

FIG. 4 illustrates a priority table showing exemplary scores for the respective on-screen texts of FIG. 3.

FIG. 5 is a flowchart of a process for prioritizing on-screen texts according to at least one embodiment of the present disclosure.

FIG. 6 is a flowchart of a process performed by a voice recognition engine for classifying a user's utterance intent from a user's utterance, according to at least one embodiment of the present disclosure.

FIG. 7 is a schematic block diagram of an illustrative configuration of a computing device that may be used to implement the method or apparatus according to the present disclosure.

### DETAILED DESCRIPTION

Hereinafter, some embodiments of the present disclosure will be described in detail with reference to the accompanying drawings. In the following description, like reference numerals preferably designate like elements, although the elements are shown in different drawings. Further, the following description of some embodiments will omit, for the purpose of clarity and brevity, a detailed description of related known components and functions when considered to obscure the subject of the present disclosure.

Various ordinal numbers or alpha codes, such as first, second, i), ii), a), b), etc., are prefixed to describe the components of embodiments of the present disclosure. They are used solely to differentiate one component from the other but not to imply or suggest the substances, order, or sequence of the components. Throughout this specification, when a part “includes” or “comprises” a component, the part is meant to further include other components, and not to exclude other components unless specifically stated to the contrary.

The description of the present disclosure to be presented below in conjunction with the accompanying drawings is intended to describe various aspects of the present disclosure and is not intended to represent the only embodiments in which the technical idea of the present disclosure may be practiced.

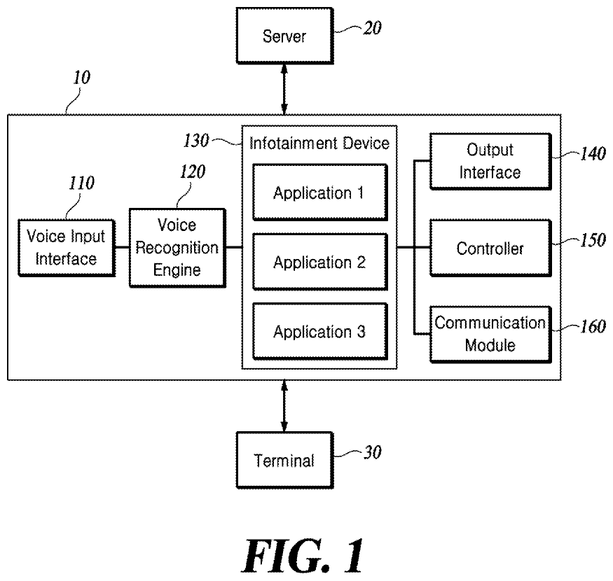

FIG. 1 is a schematic block diagram of an overall system according to at least one embodiment of the present disclosure.

Referring to FIG. 1, the overall system includes a vehicle 10, a server 20, and a terminal 30.

FIG. 1 also shows the vehicle 10 including a voice input interface 110, a voice recognition engine 120, an infotainment device 130, an output interface 140, a controller 150, and a communication module 160. Not all of the blocks shown in FIG. 1 are requisite components, and in other embodiments, some of the blocks included in the vehicle 10 may be added, changed, or deleted. Further, the components illustrated in FIG. 1 represent functionally distinct elements, and at least one of the components may be implemented in a form that integrates in an actual physical environment.

The voice input interface 110 is configured to receive voice input from a user.

The voice input interface 110 includes one or more microphones for receiving the user's utterance. The microphones may be positioned, for example, on the vehicle's steering wheel, center fascia, headlining, or room mirror to receive the user's voice input.

The voice recognition engine 120 is configured to analyze the user's voice input and transmit control commands to the infotainment device 130.

The voice recognition engine 120 may use pre-stored command tables to provide control commands corresponding to the user's voice input. The command tables may include a global command table that records information about global commands and local command tables that record information about local commands for each of the applications executed by the infotainment device 130.

First, the voice recognition engine 120 determines a voice command corresponding to the user's voice input. Specifically, the voice recognition engine 120 converts the user's utterance to text and determines the user's utterance intent from the converted text.

The voice recognition engine 120 may use the utterance intent as a voice command. In other words, the utterance intent and the voice command may be treated equally. For example, if the user's utterance is “Call <Hong Gildong>,” the voice recognition engine 120 may determine the user's utterance intent as “Call <name>,” and the voice command corresponding to the user's utterance may also be determined as “Call <name>.”

The voice recognition engine 120 then references the command table to identify a control command corresponding to the voice command. The voice recognition engine 120 transmits the identified control command to the infotainment device 130. The infotainment device 130 performs a task in accordance with the control command.

In another embodiment, the voice recognition engine 120 utilizes the server 20 to analyze the user's voice input. The voice recognition engine 120 transmits voice data to the server 20, receives analysis results of the voice data from the server 20, and generates control commands based on the analysis results. Here, the analysis result may include an utterance intent and a slot.

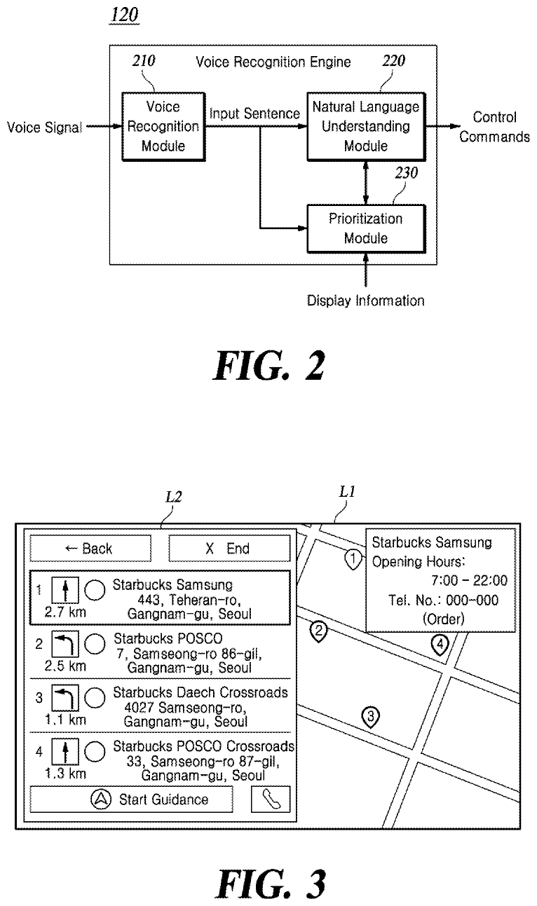

The voice recognition engine 120 is described in more detail with reference to FIG. 2.

The infotainment device 130 is adapted to provide the user with various information in voice form, visual form, or a combination thereof, in response to a control command.

The infotainment device 130 may receive control commands from the voice recognition engine 120 and perform tasks according to the received control commands.

The infotainment device 130 may execute at least one application to provide information or functionality desired by the user. For example, the infotainment device 130 may execute a phone application, a navigation application, a web portal application, a media application, etc., to provide phone functionality, destination information, weather information, music playback functionality, etc.

The output interface 140 is configured to output information provided by the infotainment device 130.

The output interface 140 may include an AVN display, a cluster display, or a head-up display (HUD) arranged on the center fascia of the vehicle 10. Alternatively, the output interface 140 may include a rear seat display that is positioned on the back of a front seat headrest for viewing by a rear seat passenger, or it may include a headlining mounted display when used in a multi-passenger vehicle.

The output interface 140 may include at least one speaker for outputting information provided by the infotainment device 130 in the form of sound.

In addition, the output interface 140 may include various other devices, such as a haptic device that generates vibrations.

The controller 150 uses the voice input interface 110 or the infotainment device 130 to perform various controls associated with the vehicle 10 based on input signals received. For example, the controller 150 may control at least one of an air conditioning unit, a window control unit, a seat heating unit, a seat adjustment unit, or a lighting unit.

The communication module 160 uses the voice input interface 110 or the infotainment device 130 to communicate with the terminal 30 based on control signals received. For example, the communication module 160 may receive from the terminal 30 audio signals for playing music, signals about the content of a call, and the like, and may send the terminal 30 signals for playing the next song, signals for making a call, and the like.

The communication module 160 may employ at least one of various wireless communication schemes, such as Bluetooth, 4G communication, 5G communication, or Wi-Fi, to send and receive signals. Alternatively, the communication module 160 may utilize a cable connected to a universal serial bus (USB) port, an auxiliary (AUX) port, etc. to send and receive information to and from other devices.

FIG. 2 is a block diagram of an utterance recognition system according to at least one embodiment of the present disclosure.

Referring to FIG. 2, the voice recognition engine 120 recognizes and understands the utterance of a user and provides control commands and/or responses corresponding to the user's utterance. In the present disclosure, the user represents a driver or passenger.

To this end, the voice recognition engine 120 includes a voice recognition module 210 that converts the user's utterance and voice commands into text, a natural language understanding module (NLU module) 220 that determines the user's utterance intent, and a prioritization module 230 that calculates a priority score of the voice commands. The voice recognition engine 120 may further include a response generation module that performs processing to provide a response corresponding to the user's utterance intent, or a dialogue manager that manages the overall conversation between the voice recognition engine 120 and the user.

The voice recognition module 210 obtains the user's utterance received from an in-vehicle microphone and converts the user's utterance to an input text string by using at least one utterance to text (STT) engine. The STT engine may apply an utterance recognition algorithm or deep learning model to a voice signal representing the user's utterance and thereby convert the voice signal to text.

For example, the voice recognition module 210 may extract a feature vector from the user's utterance by employing a feature vector extraction technique such as cepstrum, linear predictive coding (LPC), mel frequency cepstral coefficients (MFCCs), or filter bank energy. The voice recognition module 210 may obtain a recognition result by comparing the extracted feature vector with a trained reference pattern. For this purpose, an acoustic model, which models and compares the signal characteristics of the voice, or a language model, which models the linguistic ordering relation of words, syllables, etc. in the recognition vocabulary, may be used.

The voice recognition module 210 may also convert user utterance into a textual form of input text string based on a model trained with machine learning or deep learning.

The NLU module 220 categorizes the user's utterance intent based on the input text string.

In one example, the NLU module 220 may compare the input text string with a prescribed grammar to determine the user's utterance intent for the input text string. For example, when the preset grammar is “Call <name>” and the input text string is “Call Hong Gildong,” the NLU module 220 may determine that the utterance intent is “Call <name>.”

As another example, the NLU module 220 may use tokenization, deep learning models, or the like to determine the user's utterance intent for the input text string. Specifically, the NLU module 220 may segment the input text string into morphological tokens. Further, the NLU module 220 may tag each token with a word class. The NLU module 220 projects the tokens into a vector space. Each of the tokens or combination of tokens is transformed into an embedding vector. To improve performance, sequence embeddings, position embeddings, etc. may be performed together. The NLU module 220 determines the utterance intent for the input text string by grouping the embedding vectors or applying a first deep learning model and a second deep learning model to the embedding vectors, respectively. Here, the first deep learning model may be a recurrent neural network pre-trained to classify utterance intent in response to the input of the embedding vectors. The second deep learning model may be a recurrent neural network pre-trained to determine the slot in response to the input of the embedding vectors.

In at least one embodiment, the NLU module 220 may encounter a failure to classify the user's utterance intent by comparing the input text string with a prescribed grammar and/or using a deep learning model, then it may further use as a basis the input text string and the priority scores calculated by the prioritization module 230 to classify the user's utterance intent.

In another embodiment, the NLU module 220 may classify the user's utterance intent based on the priority scores and the input text string, without comparing the input text string with a prescribed grammar and/or using a deep learning model.

The prioritization module 230 may calculate a priority score for each of the on-screen texts and symbols as appeared on the display screen, which indicates the degree of relevance of each text and each symbol to the user's utterance intent. For ease of description, the term on-screen texts may be used to collectively refer to the displayed texts and symbols on the display screen.

The prioritization module 230 receives an input text string from the voice recognition module 210, and receives display information from the infotainment device 130 or the output interface 140.

The prioritization module 230 calculates priority scores of the on-screen texts based on the input text string and the display information. The NLU module 220 may classify the user's utterance intent based on the priority scores calculated by the prioritization module 230.

Since a user of an utterance recognition system often speaks by referring to what is displayed on a display screen, if the user's utterance intent is unclear, the voice recognition engine 120 can more accurately determine the user's utterance intent by considering the current on-screen content on the display screen.

The voice recognition engine 120 determines which of the on-screen texts the user has referred to and spoken. The voice recognition engine 120 then determines the utterance intent based on the text referred to by the user.

The prioritization module 230 may calculate priority score for each of the on-screen texts based on (i) the structure of the display screen, (ii) the form and content of the text, and (iii) the functionality of the GUI component, to determine the text referred to by the user on the display screen.

The prioritization module 230 may prioritize the on-screen texts based on the structure of the display screen. The structure of the display screen may include a Z-index of each of multiple layers constituting the screen and/or a hierarchical/tree structure of the texts.

The display screen of the output interface 140 may be composed of multiple layers, to provide additional information on top of the default screen or to interact with the user. Typically, each layer displays different content (e.g., lists, selection pop-ups, etc.) and has their corresponding commands.

The Z-index determines the order in which the multiple layers are stacked on the screen. The higher the Z-index value of a layer, the more the layer is preferentially displayed on the screen. The lower the Z-index value of a layer, the further the layer is blocked from viewing.

In at least one embodiment, the prioritization module 230 may prioritize the on-screen texts based on the Z-index of the layers. When the display screen is composed of multiple layers, layers with higher Z-index values have a higher priority than layers with lower Z-index values. Namely, text displayed on the top layer is prioritized higher than text displayed on the bottom layer.

In at least one embodiment, the priority of the texts based on the Z-index value may be expressed as a Z-index score. Namely, the Z-index score of the texts displayed in the top layer is determined to be higher than the Z-index score of the texts displayed in the bottom layer.

FIG. 3 illustrates a display screen composed of multiple layers.

The display screen of FIG. 3 is composed of three layers: L0, L1, and L2. Layer L0 is the home screen and is hidden from view by the other layers. The first layer L1 is an example screen displayed during the execution of the directions application, displaying Points of Interest (POIs) on a map and information about the first POI. The second layer L2 displays a list of POIs, which includes the POIs in the first layer L1.

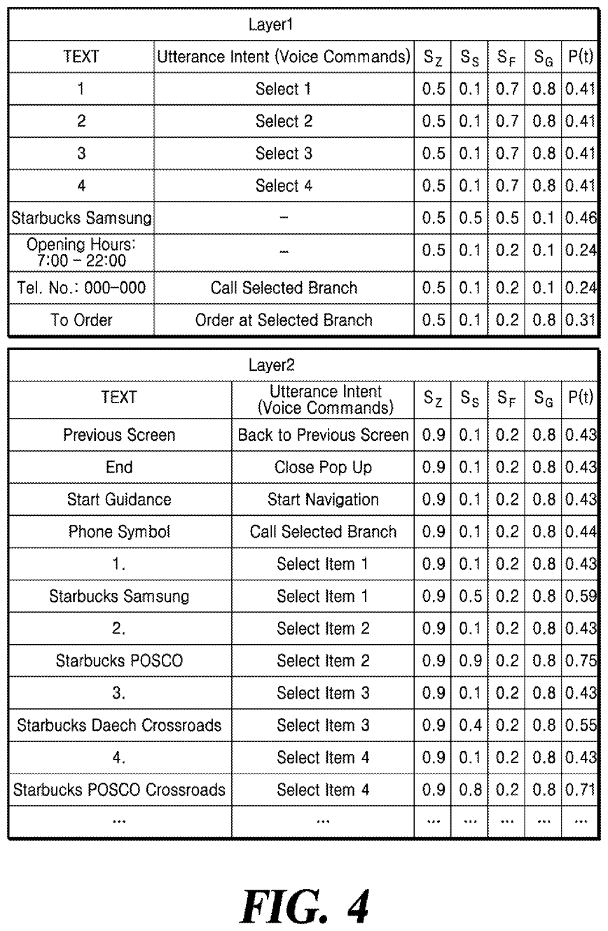

FIG. 4 illustrates priority tables showing exemplary scores for the respective on-screen texts of FIG. 3. In FIG. 4, the first table is a priority table of the texts displayed in the first layer L1 of FIG. 3, and the second table is a priority table of the texts displayed in the second layer L2 of FIG. 3.

The priority tables of FIG. 4 show exemplary Z-index scores S_{Z} of the on-screen texts of FIG. 3. Referring to FIG. 4, the second layer L2 in the example of FIG. 3 is the topmost layer, so the texts belonging to the second layer L2 have the highest Z-index score (0.9). Then, the texts belonging to the first layer L1 have somewhat high Z-index score (0.5).

Meanwhile, information or features provided by an application are often presented to the user in a hierarchical/tree structure to make it easier for the user to navigate. For example, a settings screen may display a settings menu consisting of sub-items, each of which may be selected to display a sub-setting menu consisting of smaller sub-items.

In at least one embodiment, the prioritization module 230 may calculate a priority for the on-screen texts based on a text tree structure. For example, the priority of texts belonging to lower-level items may be determined to be higher than the priority of texts belonging to higher level items.

The prioritization module 230 may prioritize the on-screen texts based on similarity and/or font style of the texts.

The user may not speak the on-screen text verbatim, but may omit or retell some of the text. Even if a user speaks the on-screen text verbatim, when the voice recognition module 210 recognizes the user's utterance and converts it to an input text string, discrepancies may occur in spacing or spelling between the user's utterance and the input text string. Similarly, there may be differences between the input text string and the on-screen text. Furthermore, there may be multiple texts similar to the user's utterance displayed on the screen.

Accordingly, the prioritization module 230 may prioritize the texts based on the similarity between the input text string and the on-screen texts. The prioritization module 230 may calculate the similarity between the input text string and the on-screen text by using an approximate string-matching algorithm that compares the similarity between two texts. For example, a fuzzy matching algorithm may be used as the approximate string-matching algorithm for comparing the similarity between two text strings, to which the present disclosure is not limited.

In at least one embodiment, the similarity between the input text string and the on-screen texts may be expressed as a similarity score.

The priority tables of FIG. 4 show exemplary similarity scores Ss of the on-screen texts of FIG. 3 when the input text string is, for example, “Starbucks POSCO Branch.”

Referring to FIG. 4, among the texts in the first layer L1, “Starbucks Samsung” has a similarity score of 0.5 because it is partially similar to the input text string, while “Opening Hours,” “Tel. No.,” etc. have a similarity score of 0.1 because they are not similar to the input text string.

Referring to FIG. 4, among the texts belonging to the second layer L2, “Starbucks Samsung,” “Starbucks POSCO,” “Starbucks Daech Crossroads,” and “Starbucks POSCO Crossroads” have high similarity to the input text string, and thus have similarity scores of 0.5, 0.9, 0.4, and 0.8, respectively. The other texts are not similar to the input text string and therefore have a similarity score of 0.1.

In this way, the prioritization module 230 may prioritize multiple similar texts like “Starbucks POSCO,” “Starbucks POSCO Crossroads,” etc. by comparing the texts with the input text string.

Meanwhile, a producer organizing the application screen may emphasize important or frequently used features by varying the font style of the respective texts displayed on the screen, when the user is likely to speak by referring to the emphasized text.

Accordingly, the prioritization module 230 may prioritize control commands based on font style. For example, when text has a large font size and is highlighted (e.g., bold, italic, etc.), the text is prioritized higher.

In at least one embodiment, the prioritization of texts based on font style may be expressed by font style scores. Namely, the font style score of text with large font size and highlighting is determined to be higher than the font style score of plain text.

The priority tables of FIG. 4 show exemplary font style scores SF of the on-screen texts of FIG. 3. Referring to FIG. 4, among the texts belonging to the first layer L1, “Opening Hours,” “Tel. No.,” etc. have a font style score of 0.1 because they are plain text, and “Starbucks Samsung” has a font style score of 0.3 because it is bold. The numbers “1,” “2,” “3,” and “4” have a font style score of 0.5 because they are larger than other text and are bold. The texts in the second layer L2 all have the same size and font style, so they have the same font style score.

The prioritization module 230 may prioritize the on-screen texts based on the functionality of the GUI component. In at least one embodiment, the priority of text written on an actionable GUI component is determined to be higher than the priority of text written on a non-actionable GUI component.

An actionable GUI component is a graphical element that a user can interact with and is designed to perform a specific task or function. For example, actionable GUI components include buttons, checkboxes, dropdown menus, toggle switches, and the like.

Since an actionable GUI component is a component for a user to interact with the system, the user is likely to speak by referring to an actionable GUI component. Therefore, text written on an actionable GUI component is given a high priority.

A non-actionable GUI component or non-interactive GUI component is the opposite of an actionable GUI component and is a graphical element that does not provide direct interaction with the user. For example, non-actionable GUI components include a label, among others.

Because non-actionable GUI components are primarily intended to display information or organize layout, users are unlikely to speak by referring to non-actionable GUI components. Therefore, text written on non-actionable GUI components is given a low priority.

On the other hand, depending on the type of actionable GUI component, the priority of the text may be determined differently. For example, the priority of the text written on a button may be determined to be higher than the priority of the text written on a checkbox. However, the present disclosure is not limited to this example.

Further, the priority may be determined differently depending on whether the GUI component carries a display of text or a symbol. For example, the priority of a button that displays text may be determined to be higher than the priority of a button that displays a symbol. However, the present disclosure is not limited to this example.

In at least one embodiment, the priority of text based on the functionality of a GUI component may be represented by a GUI component score.

The priority tables of FIG. 4 show exemplary GUI component scores S_{G} of the on-screen texts of FIG. 3.

Referring to FIG. 4, among the texts belonging to the first layer L1, the numbers “1,” “2,” “3,” “4,” and “To Order” have a GUI component score of 0.8 because they are texts written on a button, whereas “Starbucks Samsung,” “Opening Hours,” “Tel. No.,” etc. have a GUI component score of 0.1 because they are texts written on the label.

Referring to FIG. 4, the “Phone Symbol” which belongs to the second layer L2, has a GUI component score of 0.9 because it is a symbol written on the button. The rest of the text is all text written on the button, so they have a GUI component score of 0.8.

The prioritization module 230 may prioritize the texts based on the Z-index score, similarity score, font style score, GUI component score, etc. of each of the on-screen texts.

In at least one embodiment, the prioritization module 230 may prioritize the texts based on, in order: Z-index score, similarity score, font style score, and GUI component score.

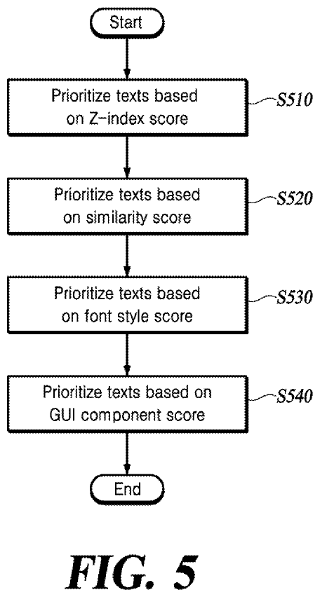

FIG. 5 is a flowchart of a process for prioritizing on-screen texts according to at least one embodiment of the present disclosure.

First, the texts are prioritized based on their Z-index scores (S510). In the example of FIG. 4, the Z-index score (0.9) of the texts belonging to the second layer L2 is higher than the Z-index score (0.5) of the texts belonging to the first layer L1, so the priority of the texts belonging to the second layer L2 is higher than the priority of the texts belonging to the first layer L1.

Secondly, the texts are prioritized based on the similarity scores (S520). In the example of FIG. 4, if the user's utterance is “Starbucks POSCO Branch,” the similarity score of “Starbucks POSCO” is the highest among the texts in the second layer L2, so the priority of “Starbucks POSCO” is given the highest priority. So, “Starbucks Crossroads” with the highest similarity score, “Starbucks Samsung” with the second highest similarity score, and “Starbucks Daechi Crossroads” with the lowest similarity score, are given higher priority in the order of their occurrence.

Thirdly, the texts are prioritized based on the font style scores (S530). In the example of FIG. 4, the remaining texts belonging to the second layer L2, except for the texts prioritized in Step S520, have the same font style score, so the remaining texts are not prioritized in Step S530.

Finally, the texts are prioritized based on the GUI component scores (S540).

In the example of FIG. 4, “Phone Symbol” has the highest GUI component score (0.9) among the texts that belong to the second layer L2 and were not prioritized in Steps S510 to S530, so “Phone Symbol” is given a high priority among the texts that were not prioritized. The remaining texts that were not prioritized are given the same priority.

In another embodiment, the prioritization module 230 may determine the priority of the texts by calculating their priority scores based on a Z-index score, a similarity score, a font style score, a GUI component score, or the like.

Equation 1 is for calculating a priority P(t) of an on-screen text t.

$$P ( t ) = w 1 \cdot Z ( t ) + w 2 \cdot S ( t ) + w 3 \cdot F ( t ) + w 4 \cdot G ( t ) \qquad Equation 1$$

Z(t) denotes the Z-index score of text t. For example, the top layer may have, but is not limited to, a Z-index score of 1, and the bottom layer may have, but is not limited to, a Z-index score of 0.1. S(t) denotes the similarity score of text t. F(t) denotes the font style score of text t. G(t) denotes the GUI component score of text t. In one example, the text in the button may have, but is not limited to, a GUI component score of 1, and the text in the label may have, but is not limited to, a GUI component score of 0.1.

Further, w₁ is a weight of the Z-index score Z(t), w₂ is a weight of the similarity score S(t), w₃ is a weight of the font style score F(t), and w₄ is a weight of the GUI component score G(t). By adjusting the relative sizes of w₁, w₂, w₃, and w₄, one can set different amounts of each score to contribute to priority. For example, w₁=0.3, w₂=0.4, w₃=0.2, and w₄=0.1. However, the present disclosure is not limited to this example.

In one example, the priority table of FIG. 4 shows the priority scores (P) of the texts, calculated by using Equation 1, where w₁=0.3, w₂=0.4, w₃=0.2, and w₄=0.1. Referring to FIG. 4, if the user's utterance is “Starbucks POSCO Branch,” then “Starbucks POSCO” becomes the text with the highest priority score (0.75). Therefore, the voice recognition engine 120 classifies “Select Item 2,” which is the utterance intent corresponding to “Starbucks POSCO,” as the user's utterance intent (voice command).

In additional embodiments, the prioritization of the text may be calculated in a manner that is a compromise between a method according to one embodiment and a method according to another embodiment.

For example, the prioritization module 230 may prioritize the texts by first prioritizing based on Z-index scores and finally calculating a priority score P(t) based on similarity scores, font style scores, GUI component scores, etc.

As another example, the prioritization module 230 may first calculate a priority score P(t) of the texts based on similarity scores, Z-index scores, and font style scores, and finally prioritize the texts having a high priority score P(t) based on a feature of the GUI component.

The NLU module 220 may determine the user's utterance intent based on the priority calculated by the prioritization module 230. For example, the NLU module 220 may determine that the voice command corresponding to the highest priority text among the on-screen texts is the user's utterance intent.

The voice recognition engine 120 may include at least one processor and a memory containing at least one command, and may execute the command by the at least one processor to perform the functions of the voice recognition module 210, the NLU module 220, and the prioritization module 230. The voice recognition engine 120 may further include a communication unit for communicating with an external device.

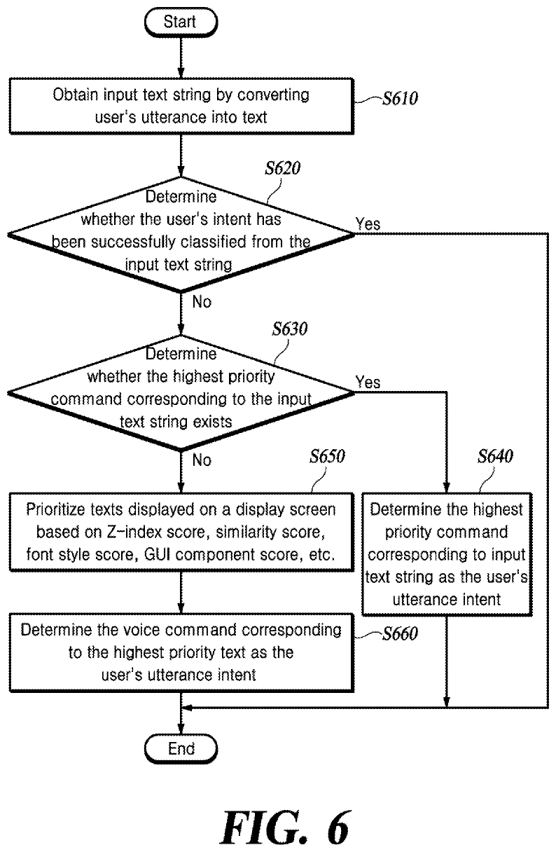

FIG. 6 is a flowchart of a process performed by the voice recognition engine 120 for classifying a user's utterance intent from the user's utterance, according to at least one embodiment of the present disclosure.

The voice recognition module 210 obtains the user's utterance received from an in-vehicle microphone and converts the user's utterance into an input text string in the form of text (S610).

The NLU module 220 classifies the user's utterance intent based on the input text string (S620). For example, the NLU module 220 may determine the user's utterance intent for the input text string by comparing the input text string with a prescribed grammar, or may determine the utterance intent for the input text string by using a deep learning model or the like.

If the NLU module 220 is successful in classifying the utterance intent (S620—Yes), a control command corresponding to the classified utterance intent is transmitted to the infotainment device 130 and/or the controller 150.

If the NLU module 220 fails to classify the utterance intent (S620—No) due to a conflict between the multiple voice commands, the NLU module 220 determines if there is a highest priority command among the multiple voice commands (S630). Here, the highest priority commands are the global commands that do not appear on the display of the output interface 140. The highest priority commands are determined to be the final commands regardless of the priority of the local commands in the event of a conflict with the local commands.

If there is a highest priority command among the multiple voice commands (S630—Yes), the NLU module 220 determines the highest priority command corresponding to the input text string as the user's utterance intent (S640). For example, the command Open, which belongs to the vehicle control domain, is the highest priority command because it is a global command that does not appear on the display. Therefore, if a user speaks “open the window,” the NLU module 220 sends a control command corresponding to command open to the infotainment device 130 and/or controller 150 without comparing priorities.

If there is no highest priority command among the multiple voice commands (S630—No), the prioritization module 230 prioritizes on-screen texts (S650). Here, the priority indicates the degree of relevance of the on-screen text to the user's utterance intent. A high priority means that the text is more likely to be relevant to the user's utterance intent, and a low priority means that the text is less likely to be relevant to the user's utterance intent. The method of prioritizing the on-screen texts is described in detail with reference to FIG. 5 and will not be elaborated again.

The NLU module 220 selects the highest priority text based on the priorities of the texts calculated by the prioritization module 230 and determines the voice command corresponding to the selected text as the user's utterance intent (S660). The NLU module 220 transmits the control command corresponding to the user's utterance intent to the infotainment device 130 and/or the controller 150.

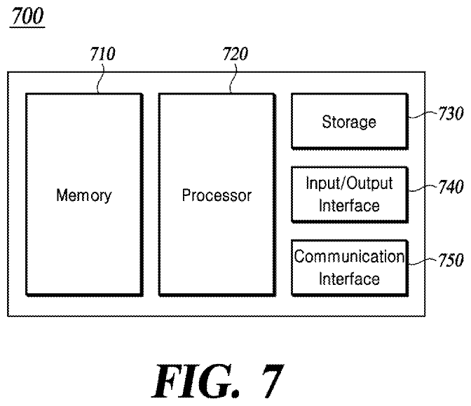

FIG. 7 is a schematic block diagram of an illustrative configuration of a computing device that may be used to implement the method or apparatus according to the present disclosure.

A computing device 700 may be provided with some or all of a memory 710, a processor 720, a storage 730, an input/output interface 740, and a communication interface 750. The computing device 700 may structurally and/or functionally include at least a portion of the apparatus according to the present disclosure. The computing device 700 may be a stationary computing device, such as a desktop computer, server, or the like, as well as a mobile computing device, such as a laptop computer, smartphone, automotive electronics or the like. The computing device 700 may include any specialized hardware accelerator capable of efficiently processing computations on the artificial intelligence model. For example, the computing device 700 may include a graphics processing unit (GPU), a tensor processing unit (TPU), or a neural processing unit (NPU).

The memory 710 may store programs that cause the processor 720 to perform methods or operations under various embodiments of the present disclosure. For example, the program may include a plurality of instructions executable by the processor 720, and the plurality of instructions may be executed by the processor 720 to perform the methods or operations described above. The memory 710 may be a single memory or a plurality of memories. For example, the information required to perform the methods or operations according to various embodiments of the disclosure may be stored in a single memory or stored divisively among the plurality of memories. When the memory 710 is composed of a plurality of memories, they may be physically separated. The memory 710 may include at least one of volatile memory and non-volatile memory. The volatile memory may include static random access memory (SRAM) or dynamic random access memory (DRAM), for example, and the non-volatile memory may include flash memory, for example.

The processor 720 may include at least one core capable of executing at least one set of instructions. The processor 720 may execute instructions stored in the memory 710. The processor 720 may be a single processor or a plurality of processors.

The storage 730 maintains stored data even when power to the computing device 700 is interrupted. For example, the storage 730 may include non-volatile memory or may include a storage medium, such as magnetic tape, optical disk, or magnetic disk. Programs stored in the storage 730 may be loaded into the memory 710 before execution by the processor 720. The storage 730 may store files written in a programming language, and programs generated by a compiler or the like may be loaded from the files into the memory 710. The storage 730 may store data to be processed by the processor 720 and/or data that has been processed by the processor 720.

The input/output interface 740 may provide an interface with an input device, such as a keyboard, mouse, etc., and/or with an output device, such as a display device, printer, etc. A user can trigger the execution of a program by the processor 720 via the input device and/or view the results of processing by the processor 720 via the output device.

The communication interface 750 may provide access to an external network. The computing device 700 may communicate with other devices via the communication interface 750.

The respective components of the apparatus and method may be implemented as hardware or software, or hardware and software combined. Additionally, the function of each component may be implemented by software, and the function by software for each component may be implemented to be executed by a microprocessor.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) contain instructions for a programmable processor and are stored in a “computer-readable recording medium.”

The computer-readable recording medium includes any type of recording device on which data that can be read by a computer system is recordable. Examples of computer-readable recording media include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Further, the computer-readable recording medium can be distributed in computer systems connected via a network, wherein the computer-readable codes can be stored and executed in a distributed mode.

Although the steps in the respective flowcharts/timing charts are described in this specification as being sequentially performed, they merely instantiate the technical idea of some embodiments of the present disclosure. Therefore, a person having ordinary skill in the pertinent art to the respective embodiments could perform the steps without departing from the idea and scope of the embodiments by changing the sequences described in the respective flowcharts/timing charts or by performing two or more of the steps in parallel, and hence the steps in the respective flowcharts/timing charts are not limited to the illustrated chronological sequences.

Although various aspects of the present disclosure have been described for illustrative purposes, those skilled in the art will appreciate that various modifications, additions, and substitutions are possible without departing from the idea and scope of the present disclosure. Therefore, various aspects of the present disclosure have been described for the sake of brevity and clarity. The scope of the technical idea of the embodiments of the present disclosure is not limited by the illustrations. Accordingly, one of ordinary skill would understand that the scope of the present disclosure is not to be limited by the above explicitly described embodiments but by the claims and equivalents thereof.

What is claimed is:

1. A computer-implemented method performed by a computing device to execute voice commands, comprising:
obtaining, by the computing device, an input text string by converting a user's utterance into text;
determining, by the computing device, whether the input text string is classified into a highest priority command; and
either (i), or both (ii) and (iii):
(i) executing, by the computing device, based on the input text string being classified as the highest priority command, the classified highest priority command; or
(ii) determining, by the computing device, based on the input text string not being classified into the highest priority command, a priority of a plurality of texts displayed on a display screen; and
(iii) executing, by the computing device, a voice command that corresponds to a highest priority text among the plurality of texts,
wherein the highest priority command is a global voice command that is not displayed on the display screen, and
wherein the priority is determined based on a degree of relevance of text among the plurality of texts displayed on the display screen to an intent of the user's utterance.

2. The computer-implemented method of claim 1, wherein the input text string is classified as the highest priority command, and the computer-implemented method comprises the executing of the classified highest priority command.

3. The computer-implemented method of claim 1, wherein the determining of the priority is performed based on a Z-index value assigned to each of a plurality of screen layers on the display screen.

4. The computer-implemented method of claim 1, wherein the determining of the priority comprises,
calculating a similarity of each of the plurality of texts to the input text string utilizing an approximate string-matching algorithm; and
determining a priority of the plurality of texts based on the similarity of each of the plurality of texts.

5. The computer-implemented method of claim 4, wherein the approximate string-matching algorithm comprises a fuzzy matching algorithm.

6. The computer-implemented method of claim 1, wherein the determining of the priority comprises:
determining the priority of the plurality of texts based on font styles of the plurality of texts.

7. The computer-implemented method of claim 1, wherein the determining of the priority comprises:
determining the priority of the plurality of texts based on whether each GUI component displaying the plurality of texts is an actionable GUI component.

8. The computer-implemented method of claim 1, wherein the determining of the priority comprises:
calculating a priority score for each of the plurality of texts based on (i) a Z-index score, (ii) a similarity score, (iii) a font style score, (iv) a GUI component score, or any combination of (i) to (iv),
wherein the Z-index score is calculated based on a Z-index value assigned to each of a plurality of layers comprising the display screen,
wherein the similarity score is calculated by comparing the input text string to the text displayed on the display screen by utilizing an approximate string-matching algorithm,
wherein the font style score is calculated based on a font style of the text displayed on the display screen, and
wherein the GUI component score is calculated based on whether a GUI component is actionable.

9. The computer-implemented method of claim 8, wherein the priority score is a weighted sum of the Z-index score, the similarity score, the font style score, and the GUI component score.

10. The computer-implemented method of claim 1, wherein the plurality of texts comprises:
symbols displayed on the display screen.

11. An apparatus to execute voice commands based on display information, comprising:
at least one memory configured to store commands; and
at least one processor,
wherein the at least one processor is configured to execute the commands to:
determine an input text string by converting user's utterance into text;
determine whether the input text string is classified into a highest priority command; and
either (i), or both (ii) and (iii):
(i) execute, based on the input text string being classified into the highest priority command, the classified highest priority command; or
(ii) determine, based on the input text string not being classified into the highest priority command, a priority of a plurality of texts displayed on a display screen; and
(iii) execute a voice command that corresponds to a highest priority text among the plurality of texts,
wherein the highest priority command is a global voice command that is not displayed on the display screen, and
wherein the priority represents a degree of relevance of text among the plurality of texts displayed on the display screen to an intent of the user's utterance.

12. The apparatus of claim 11, wherein the input text string is classified into the highest priority command, and the processor is configured to execute the classified highest priority command.

13. The apparatus of claim 11, wherein the priority of the plurality of texts is determined based on a Z-index value assigned to each of a plurality of screen layers displayed on the display screen.

14. The apparatus of claim 11, wherein the priority of the plurality of texts is determined based on a similarity of each of the plurality of texts to the input text string, and
wherein the similarity is calculated by comparing the input text string with the text displayed on the display screen by utilizing an approximate string-matching algorithm.

15. The apparatus of claim 14, wherein the approximate string-matching algorithm comprises a fuzzy matching algorithm.

16. The apparatus of claim 11, wherein the priority of the plurality of texts is determined based on font styles of the plurality of texts.

17. The apparatus of claim 11, wherein the priority of the plurality of texts is determined based on whether each GUI component displaying the plurality of texts is an actionable GUI component.

18. The apparatus of claim 11, wherein the priority of the plurality of texts is determined based on priority scores calculated based on (i) a Z-index score, (ii) a similarity score, (iii) a font style score, (iv) a GUI component score, or any combination of (i) to (iv),
wherein the Z-index score is calculated based on a Z-index value for each of a plurality of layers comprising the display screen,
wherein the similarity score is calculated by comparing the input text string to the text displayed on the display screen by utilizing an approximate string-matching algorithm,
wherein the font style score is calculated based on a font style of the text displayed on the display screen, and
wherein the GUI component score is calculated based on whether a GUI component is actionable.

19. The apparatus of claim 18, wherein a priority score among the priority scores is a weighted sum of the Z-index score, the similarity score, the font style score, and the GUI component score.

20. The apparatus of claim 11, wherein the plurality of texts comprises:
symbols displayed on the display screen.
